(19) United States
(12) Patent Application Publication
(10) Pub. No.: US 2016/0103277 A1
(43) Pub. Date: Apr. 14, 2016

(54) BACKLIGHT MODULE AND DISPLAY APPARATUS

(71) Applicants: BOE Technology Group Co., Ltd., Beijing (CN); BOE Optical Science and Technology Co., Ltd., Suzhou (CN)

(72) Inventors: Jijun Wu, Beijing (CN); Yongli Yao, Beijing (CN)

(21) Appl. No.: 14/801,070

(22) Filed: Jul. 16, 2015

(30) Foreign Application Priority Data
Oct. 10, 2014 (CN) 201410532227.0

(51) Int. Cl. F21V 8/00

(52) U.S. Cl. CPC G02B 6/0091; G02B 6/0053; G02B 6/0051; G02B 6/0068; G02B 6/0083

(57) ABSTRACT

The present disclosure provides a backlight module and a display apparatus. The backlight module includes: a substrate configured to fix a plurality of light sources; the plurality of light sources fixed on the substrate and connected electrically to each other; and a light guide plate having at least one side on which a recess portion for receiving the plurality of light sources or receiving the plurality of light sources and at least part of the substrate is provided. At least the plurality of light sources are embedded into the recess portion, thus, the light emitted from the plurality of light sources may enter the light guide plate completely for utilization. Not only the brightness of the backlight module may be improved, but also the energy waste due to the part of the light of the plurality of light sources failing to enter the light guide plate may be avoided. And, at least the plurality of light sources being embedded into the recess portion may also reduce the width of non-light emitting region on a light incidence side of the backlight module, so as to reduce the width of the frame of the backlight module and to increase an effective light emitting area of the backlight module.

### CROSS-REFERENCE TO RELATED APPLICATION

This application claims the benefit of Chinese Patent Application No. 201410532227.0 filed on Oct. 10, 2014 in the State Intellectual Property Office of China, the whole disclosure of which is incorporated herein by reference.

### BACKGROUND OF THE INVENTION

1. Field of the Invention

The present disclosure relates to a technical field of display, and in particular, relates to a backlight module and a display apparatus.

2. Description of the Related Art

The conventional electronic products having a display function, such as TV, a display apparatus, a digital camera, a mobile phone, a palm digital assistant (PDA), a portable digital versatile optical disc player, all display audio and video signals by a liquid crystal panel configuration. The video display of the liquid crystal panel significantly depends on the design and quality management of the backlight module.

The conventional backlight module, as illustrated in FIG. 1a, FIG. 1b, FIG. 2a and FIG. 2b (FIG. 1b is a cross sectional view taken along line A-A in FIG. 1a, and FIG. 2b is a cross sectional view taken along line B-B in FIG. 2a), includes a sealing frame 101, a light guide plate 102 within the sealing frame 101, a flexible printed circuit board (FPC) 103 fixed on the sealing frame 101 (as illustrated in FIG. 1a and FIG. 1b) or the light guide plate 102 (as illustrated in FIG. 2a and FIG. 2b) and a plurality of light sources 104 fixed on FPC 103. The plurality of light sources 104 are located on a lateral side of the light guide plate 102 and electrically connected by the FPC 103. The lights emitted from the plurality of light sources 104 enter the lateral side and outgo from a front side of the light guide plate 102.

In the above configuration of the backlight module, as there is a certain distance between the plurality of light sources and a light incidence face of the light guide plate, only part of the light emitted from the plurality of light sources can enter the light guide plate for utilization. In this way, not only the brightness of the backlight module may be degraded, but also the energy for the plurality of light sources may be wasted. In addition, the above backlight module configuration has a wide frame and a small effective light emitting area, and thus is not in conformity with the narrow frame trend of development of the backlight module.

Therefore, it is desired for the skilled person in the art to optimize the configuration of the backlight module.

### SUMMARY OF THE INVENTION

In view of this, an embodiment of the present invention provides a backlight module and a display apparatus for optimizing the configuration of the backlight module.

Therefore, an embodiment of the present invention provides a backlight module, and the backlight module comprises:
a substrate configured to fix a plurality of light sources;
the plurality of light sources fixed on the substrate and connected electrically to each other; and
a light guide plate having at least one side on which a recess portion for receiving the plurality of light sources or receiving the plurality of light sources and at least part of the substrate is provided,
wherein at least the plurality of light sources are embedded into the recess portion.

An embodiment of the present invention also provides a display apparatus comprising the backlight module as described in the above embodiment.

### BRIEF DESCRIPTION OF THE DRAWINGS

FIG. 1a is a first view schematically showing a configuration of the conventional backlight module;

FIG. 1b is a cross sectional view taken along line AA in FIG. 1a;

FIG. 2a is a second view schematically showing a configuration of the conventional backlight module;

FIG. 2b is a cross sectional view taken along line BB in FIG. 2a; and

FIGS. 3-5 are views schematically configurations of backlight modules according to embodiments of the present invention respectively.

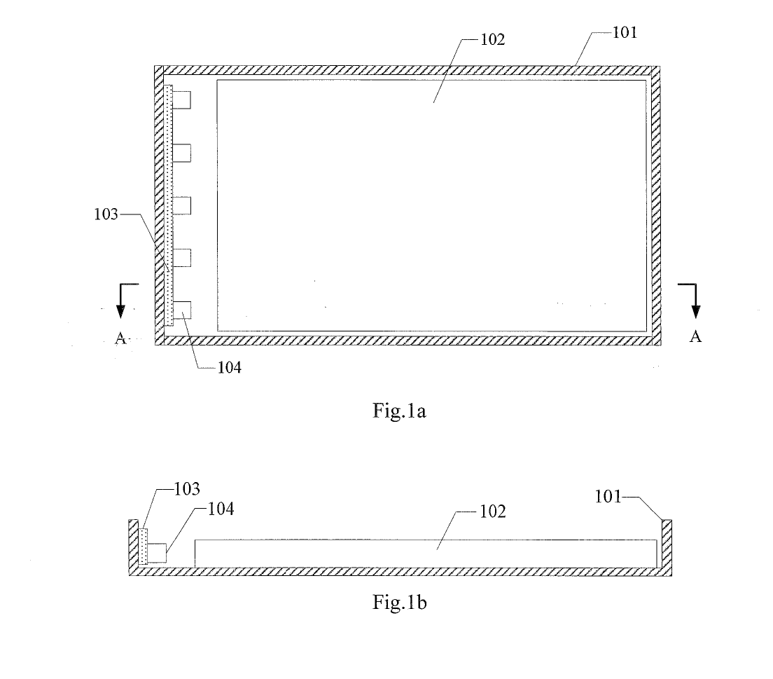

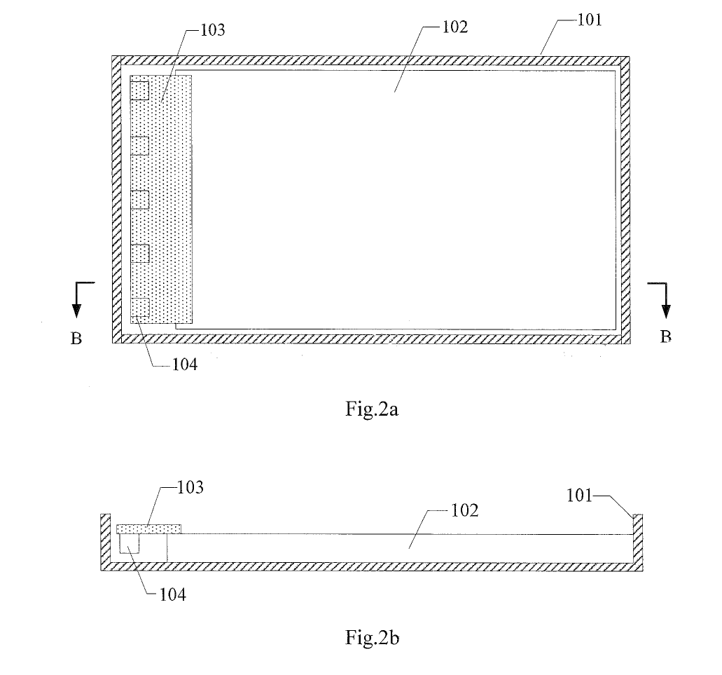

### DETAILED DESCRIPTION OF PREFERRED EMBODIMENTS OF THE INVENTION

Exemplary embodiments of the present disclosure will be described below in detail with reference to figures. Apparently, the following embodiments are part of the embodiments of the present invention, instead of all of the embodiments. On the basis of the following embodiments, the skilled person in the art can obtain other embodiments without taking inventive labors. All of the other embodiments fall within the scope of the present invention.

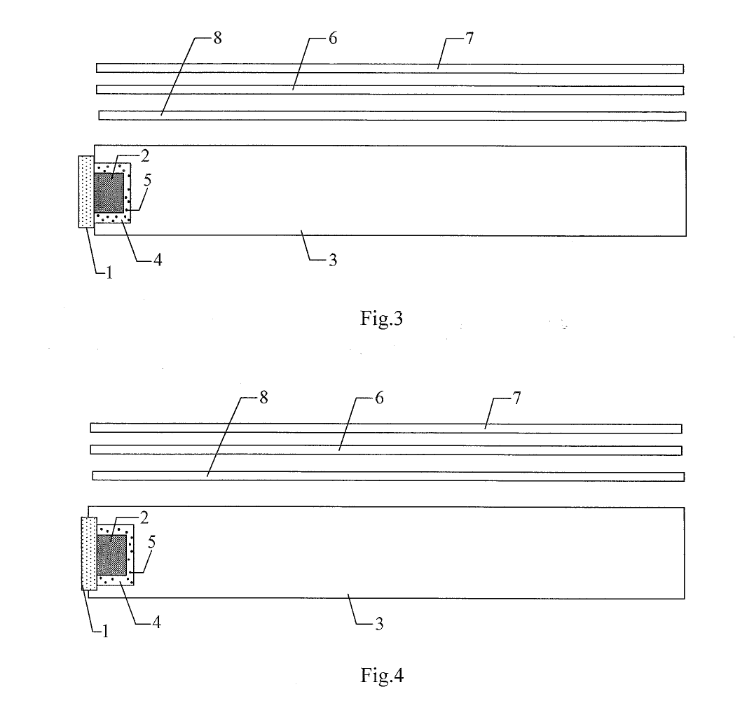

An embodiment of the present invention provides a backlight module, as illustrated in FIGS. 3-5. The backlight module includes:
a substrate 1 configured to fix a plurality of light sources 2;
the plurality of light sources 2 fixed on the substrate 1 and connected electrically to each other; and
a light guide plate 3 having at least one sides on which a recess portion for receiving the plurality of light sources 2 or receiving the plurality of light sources 2 and at least part of the substrate 1 is provided;

At least the plurality of light sources 2 are embedded into the recess portion.

In the above backlight module provided by the embodiment of the present invention, at least the plurality of light sources 2 are embedded into the recess portion, thus, the light emitted from the plurality of light sources may enter the light guide plate completely for utilization. Not only the brightness of the backlight module may be improved, but also the energy waste due to the part of the light of the plurality of light sources failing to enter the light guide plate may be avoided. In addition, at least the plurality of light sources being embedded into the recess portion may also reduce the width of non-light emitting region on a light incidence side of the backlight module, so as to reduce the width of the frame of the backlight module and to increase an effective light emitting area of the backlight module.

It should be noted that FIGS. 3-5 are all side views of the above backlight module provided by the embodiments of the present invention. In the backlight module shown in FIGS. 3-5, the plurality of light sources 2 in particular may be arranged uniformly on the substrate 1 along a straight line perpendicular to the page.

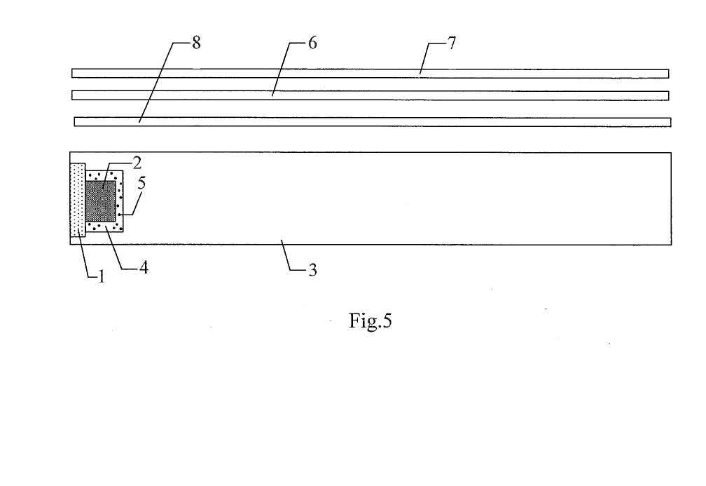

In practice, in the above backlight module provided by the embodiment of the present invention, FIGS. 3-5 all show the recess portion is arranged on one lateral side of the light guide plate 3 by way of examples. In an example, as illustrated in FIG. 3, the recess portion of the light guide plate 3 can only receive the plurality of light sources 2 and the substrate 1 in entirety is located out of the light guide plate 3. Or, as shown in FIG. 4, the recess portion of the light guide portion 3 may receive the plurality of light sources 2 and a part of the substrate 1 and the remainder of the substrate 1 is located out of the light guide plate 3. Alternatively, as illustrated in FIG. 5, the recess portion of the light guide plate 3 may also receive the plurality of light sources 2 and the substrate 1 with only one side of the substrate 1 away from the plurality of light sources 2 being exposed out of the light guide plate 3. That is, the plurality of light sources 2 and the substrate 1 are just embedded into the recess portion of the light guide plate 3. It is not limited herein. It should be understood that, by exposing only one side of the substrate 1 away from the plurality of light sources 2 out of the light guide plate 3, the substrate 1 may be positioned and fixed by means of the light guide plate 3. In this way, the problems such as inaccuracy and low yield due to coating adhesives manually onto the substrate 1 are relieved.

In the configuration of the backlight module shown in FIG. 5, the plurality of light sources 2 are embedded into the recess portion of the light guide plate 3 completely, thus, the light emitted from the plurality of light sources 2 may enter the light guide plate 3 completely for utilization. Not only the brightness of the backlight module may be improved, but also the energy waste due to the part of the light emitted from the plurality of light sources failing to enter the light guide plate 3 may be avoided. In addition, the substrate 1 in entirety is embedded into the recess portion of the light guide plate 3 completely. In this way, it may reduce the width of non-light emitting region on a light incidence side of the backlight module to maximum extent, so as to reduce the width of the frame of the backlight module to maximum extent and to increase an effective light emitting area of the backlight module, even it may form a frameless backlight module.

As an example, in the above backlight module provided by the embodiment of the present invention, as shown in FIGS. 3-5, surfaces of the plurality of light sources 2 may be coated with sealing adhesives 4. The plurality of light sources 2 are adhered to each other by the sealing adhesives 4 and the light guide plate 3.

As an example, in the above backlight module provided by the embodiment of the present invention, the plurality of light sources may in particular be light emitting diodes (LED) that emit monochromatic light. Or the plurality of light sources may also be cold cathode fluorescent lamp (CCFL) that emit white light. They are not limited herein. In case that the plurality of light sources may in particular be LEDs that emit monochromatic light, in order to make the backlight module emit the white light, as illustrated in FIGS. 3 and 5, the sealing adhesives 4 coated on the surfaces of the LEDs may be doped with fluorescent powders 5. In this way, the monochromatic light emitted from the LEDs excites the fluorescent powders 5 such that the backlight module may emit the white light.

As an example, in the above backlight module provided by the embodiment of the present invention, the substrate may be in particular an insulated flat plate. Conductive material such as ink may be used to form scribing lines on the flat plate to electrically connect the pins of the plurality of light sources. It is not limited herein. And the plurality of light sources may be connected in series, or in parallel. It is not limited herein.

As an example, in the above backlight module provided by the embodiment of the present invention, the substrate may be in particular a flexible printed circuit board (FPC), and the plurality of light sources are electrically connected with the flexible printed circuit board and thus the plurality of light sources are electrically connected together. The FPC not only may connect the plurality of light sources, but also may fix them.

As an example, the above backlight module provided by the embodiment of the present invention, as shown in FIGS. 3-5, may further include a lower light intensifying plate 6 and an upper light intensifying plate 7 located on a light emitting side of the light guide plate 3. The lower light intensifying plate 6 and the upper light intensifying plate 7 may have a function of increasing the brightness of the backlight module.

As an example, the above backlight module provided by the embodiment of the present invention, as shown in FIGS. 3-5, may further include a diffusion plate 8 located between the light guide plate 3 and the lower light intensifying plate 6. The diffusion plate 8 may make the light emitted from the backlight module become more uniform.

It should be noted that the above backlight module provided by the embodiment of the present invention may be applied in products with middle size such as those in cars, those in industrial control or those in tablet computer, in particular, suitable for products with small size such as cell phone.

In accordance with the same invention concept, an embodiment of the present invention also provides a display apparatus comprising the backlight module as provided by any of the above embodiments. The display apparatus may be any products or components having display function such as a cell phone, a tablet computer, a TV, a display, a notebook computer, a digital camera frame, a navigator. The implementation of the display apparatus may be based on the above embodiments of the backlight module. The repeated details will be omitted.

An embodiment of the present invention provides a backlight module and a display apparatus. The backlight module includes: a substrate configured to fix a plurality of light sources; the plurality of light sources fixed on the substrate and connected electrically to each other; and a light guide plate having at least one sides on which a recess portion for receiving the plurality of light sources or receiving the plurality of light sources and at least part of the substrate. At least the plurality of light sources are embedded into the recess portion, thus, the light emitted from the plurality of light sources may enter the light guide plate completely for utilization. Not only the brightness of the backlight module may be improved, but also the energy waste due to the part of the light of the plurality of light sources failing to enter the light guide plate may be avoided. In addition, at least the plurality of light sources being embedded into the recess portion may also reduce the width of non-light emitting region on a light incidence side of the backlight module, so as to reduce the width of the frame of the backlight module and to increase an effective light emitting area of the backlight module.

Although several exemplary embodiments have been shown and described, the present invention is not limited to those and it would be appreciated by those skilled in the art that various changes or modifications may be made in these embodiments without departing from the principles and spirit of the disclosure. These changes or modifications will also be intended to belong to the present invention as long as they fall within the scope of the appended claims and their equivalents.

What is claimed is,:

1. A backlight module, comprising:
a substrate configured to fix a plurality of light sources;
the plurality of light sources fixed on the substrate and electrically connected to each other; and
a light guide plate having at least one side on which a recess portion for receiving the plurality of light sources or receiving the plurality of light sources and at least part of the substrate is provided,
wherein at least the plurality of light sources are embedded into the recess portion.

2. The backlight module according to claim 1, wherein the recess portion is configured to receive the plurality of light sources and the substrate with only one side of the substrate away from the plurality of light sources being exposed out of the light guide plate.

3. The backlight module according to claim 1, wherein surfaces of the plurality of light sources are coated with sealing adhesives.

4. The backlight module according to claim 1, wherein the plurality of light sources are light emitting diodes.

5. The backlight module according to claim 3, wherein the sealing adhesives are doped with fluorescent powders.

6. The backlight module according to claim 1, wherein the substrate is an insulated flat plate, and the plurality of light sources are electrically connected by ink scribing lines on the flat plate.

7. The backlight module according to claim 2, wherein the substrate is an insulated flat plate, and the plurality of light sources are electrically connected by ink scribing lines on the flat plate.

8. The backlight module according to claim 3, wherein the substrate is an insulated flat plate, and the plurality of light sources are electrically connected by ink scribing lines on the flat plate.

9. The backlight module according to claim 4, wherein the substrate is an insulated flat plate, and the plurality of light sources are electrically connected by ink scribing lines on the flat plate.

10. The backlight module according to claim 1, wherein the substrate is a flexible printed circuit board, and the plurality of light sources are electrically connected with the flexible printed circuit board.

11. The backlight module according to claim 2, wherein the substrate is a flexible printed circuit board, and the plurality of light sources are electrically connected with the flexible printed circuit board.

12. The backlight module according to claim 1, further comprising a lower light intensifying plate and an upper light intensifying plate located on a light emitting side of the light guide plate.

13. The backlight module according to claim 2, further comprising a lower light intensifying plate and an upper light intensifying plate located on a light emitting side of the light guide plate.

14. The backlight module according to claim 12, further comprising a diffusion plate located between the light guide plate and the lower light intensifying plate.

15. A display apparatus comprising the backlight module according to claim 1.
